(19) United States
(12) Patent Application Publication
(10) Pub. No.: US 2013/0247344 A1
(43) Pub. Date: Sep. 26, 2013

(54) TUBULAR THREAD SEAL

(71) Applicant: Brody Aycock, Spanish Fork, UT (US)

(72) Inventor: Brody Aycock, Spanish Fork, UT (US)

(21) Appl. No.: 13/797,512

(22) Filed: Mar. 12, 2013

Related U.S. Application Data
(60) Provisional application No. 61/615,651, filed on Mar. 26, 2012.

(51) Int. Cl. F16J 15/10; F16J 15/06

(52) U.S. Cl. CPC F16J 15/104; F16J 15/061
USPC 29/235; 277/607; 30/123

(57) ABSTRACT

For sealing a threaded connection, a tubular thread seal includes a proximal edge with a specified proximal diameter and a distal edge with a specified distal diameter. The distal edge is inserted over a threaded connection. The tube is disposed between the proximal edge and the distal edge.

### CROSS-REFERENCE TO RELATED APPLICATIONS

this application is a continuation of and claims priority to U.S. Provisional Patent Application Ser. No. 61/615,651, entitled “TUBULAR THREAD SEAL” and filed on Mar. 26, 2012 for Brody Aycock which is Incorporated herein by reference.

### BACKGROUND

1. Field

The subject matter disclosed herein relates to thread seal and more particularly relates to tubular thread seal.

2. Description of the Related Art

Thread seal tape is useful for sealing threaded connections but is difficult to apply.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a perspective drawing illustrating one embodiment of a tubular thread seal;

FIG. 2 is a perspective drawing illustrating one alternate embodiment of a tubular thread seal;

FIG. 3 is a perspective drawing illustrating one alternate embodiment of a tubular thread seal;

FIG. 4 is a perspective drawing illustrating one alternate embodiment of a tubular thread seal;

FIG. 5 is a perspective drawing illustrating one alternate embodiment of a tubular thread seal; and

FIG. 6 is a perspective drawing illustrating one embodiment of an application tool.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

The schematic flowchart diagrams and/or schematic block diagrams in the Figures illustrate the architecture, functionality, and operation of possible implementations. It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Although various arrow types and line types may be employed in the flowchart and/or block diagrams, they are understood not to limit the scope of the corresponding embodiments. Indeed, some arrows or other connectors may be used to indicate only an exemplary logical flow of the depicted embodiment.

The description of elements in each figure may refer to elements of proceeding figures. Like numbers refer to like elements in all figures, including alternate embodiments of like elements.

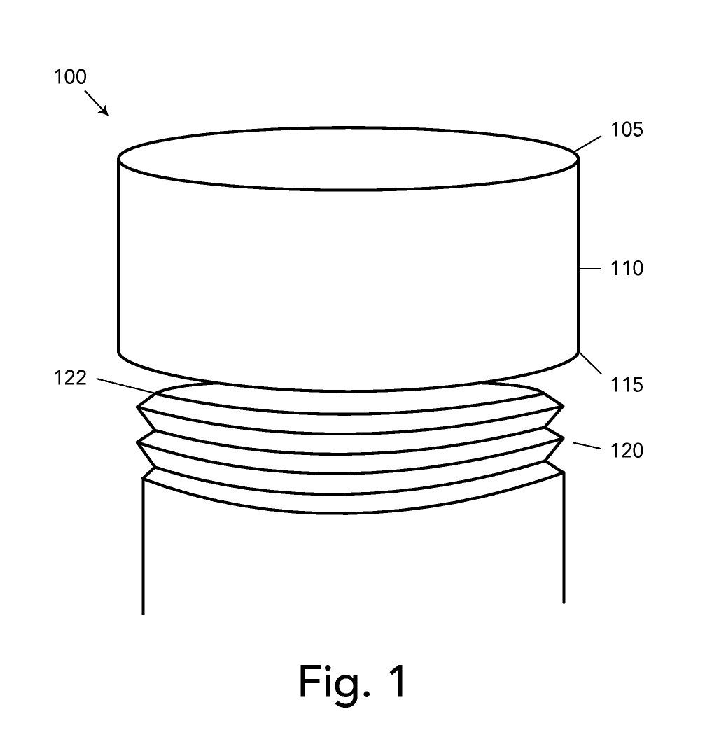

FIG. 1 is a perspective drawing illustrating one embodiment of a tubular thread seal 100. The tubular thread seal 100 includes a proximal edge 105, a distal edge 115, and a tube 110. The proximal edge 105 has a specified proximal diameter. The distal edge 115 has a specified distal diameter. The tube 110 is disposed between the proximal edge 105 and the distal edge 115.

The tube 110 is shown as a cylinder. One of skill in the art will recognize that the embodiments may also be practiced with a tube 110 that has a square cross-section, a rectangular cross-section, a triangular cross-section, and the like. The interior of the tube 110 may be a flat surface, a ridged surface, and a textured surface. The tube 110 may be thicker towards the distal edge 115. Alternatively, the tube 110 may be thicker towards the proximal edge 105.

The tubular thread seal 100 may be inserted over a threaded connection 120. In one embodiment, the distal edge 115 is inserted over the threaded connection 120 until the tube 110 covers the thread connection 120. The tube 100 may seal the threaded connection 120. The threaded connection 120 includes a threaded connection proximal end 122.

In one embodiment, the specified proximal diameter is in the range of 10-105% of a diameter of the threaded connection 120. In addition, the specified distal diameter may be in the range of 15-110% of the diameter of the threaded connection 120. The tube 110 may have a diameter in the range of 0.3 to 15 centimeters (cm). Alternatively tube 110 may have a diameter in the range of ⅛ to 6 inches. In addition, the tube 110 may have a length in the range of 0.3 to 16 cm. Alternatively, the tube 110 may have a length in the range of ⅛ to 6 inches. In one embodiment, the tube 110, the proximal edge 105, and/or the distal edge 115 may be stretched to larger diameters.

The tube 110 may be labeled. The label may be stamped, silkscreened, printed, laser etched, or the like. In one embodiment, the label comprises a removable tag upon which the size of the tube 110 is marked. In one embodiment, the marking may be raised. Alternatively, the marking may be depressed into the material of the label and/or the tube 110

In a certain embodiment, the tube 110 and/or the label may be color-coded. In one embodiment the color coding indicates the diameter of the tube 110. Alternatively, the color coding may indicate a type of pipe for which the tube 110 is to be used. For example, the tube 110 and/or the label may be color-coded for a gas pipe, a water pipe, and air pipe, and the like.

In one embodiment, the tube 110 is formed of a polymer. In addition, the tube 110 may be an elastomer. The tube 110 may have a roughness Ra in the range of 100,000 to 20,000. In a certain embodiment, the tube 110 is polytetrafluoroethylene.

In one embodiment, plumbers paste is disposed on the interior of the tube 110. Alternatively, plumbers paste may be disposed on the exterior tube 110. In a certain embodiment, the plumbers paste may be packaged separately from the tube 110 and may be applied to the tube 110 by the user.

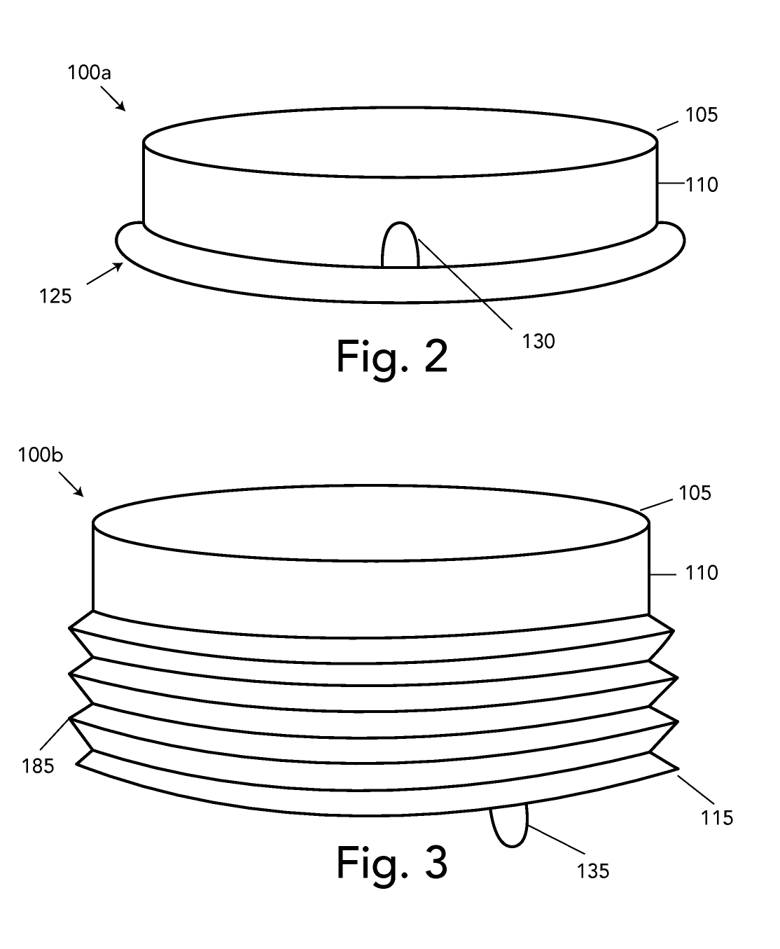

FIG. 2 is a perspective drawing illustrating one alternate embodiment of a tubular thread seal 100a. The tube 110 is depicted rolled from the distal edge 115 with the roll 125 curvature outside the tube 110. In one embodiment, the roll 125 is placed over the thread of connection 120. The roll 125 and tube 110 may be unrolled from the threaded connection proximal end 122 over the threaded connection 120.

In one embodiment, a role tab 130 is rolled into the roll 125 of the tube 110. Pulling the roll tab 130 unrolls the tube 110 to extend over the threaded connection 120.

FIG. 3 is a perspective drawing illustrating one alternate embodiment of a tubular thread seal 100b. The tube 110 is folded with an accordion fold 185. The distal edge 115 may be placed over the threaded connection proximal end 122 and the accordion fold 185 extended over the threaded connection 120.

In one embodiment, a pull tab 135 is disposed on the distal edge 115. Pulling the pull tab 135 may extend the accordion fold 185 over the threaded connection 120.

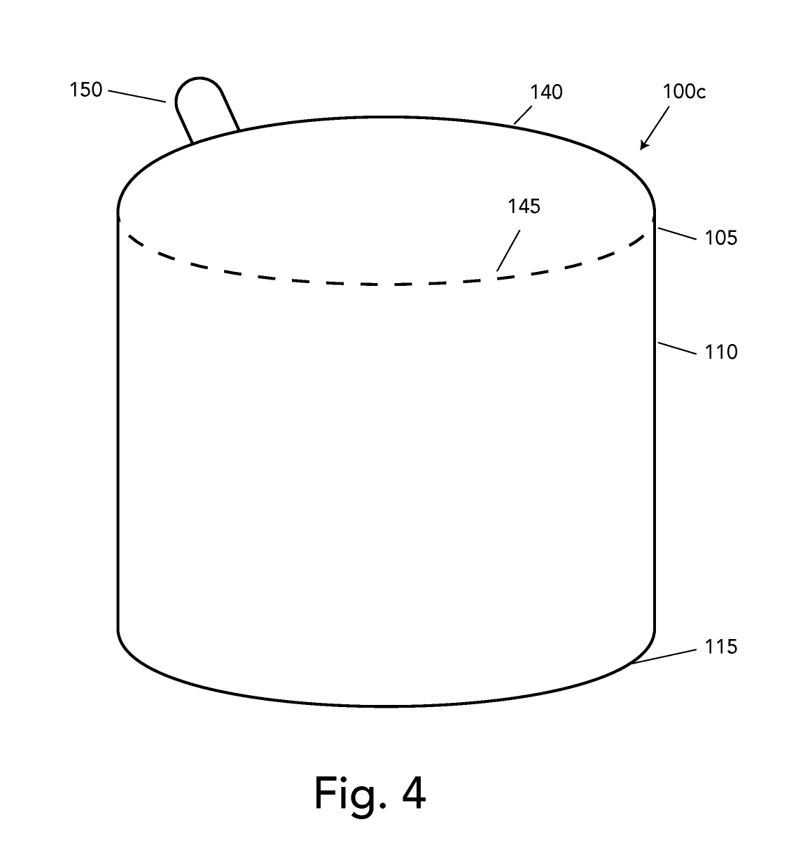

FIG. 4 is a perspective drawing illustrating one alternate embodiment of a tubular thread seal 100c. An end cap 140 at least partially connects the edges of the proximal edge 105. In one embodiment, a perforation 145 separates the end cap 140 from the proximal edge 105. The end cap 140 may be removed from the tube 110 by tearing along the perforation 145. In one embodiment, the end cap 140 includes a cap tab 150. Pulling on the cap tab 150 may remove the end cap 140 from the tube 110. In an alternate embodiment, an end removal tool may cut the end cap 140 from the tube 110.

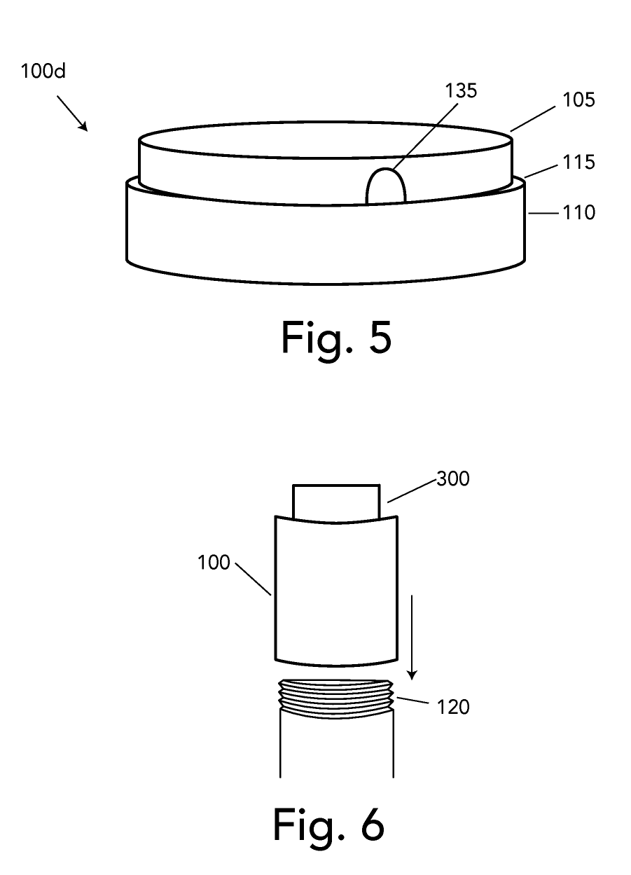

FIG. 5 is a perspective drawing illustrating one alternate embodiment of a tubular thread seal 100d. The distal edge 115 is folded over the tube 110 toward the proximal edge 105. The distal edge 115 may be unfolded from the proximal end 122 of the threaded connection 120 over the threaded connection 120. A pull tab 135 may be disposed on the distal edge 115. The pull tab 135 may be used to pull the distal edge 115 over the threaded connection 120.

FIG. 6 is a perspective drawing illustrating one embodiment of an application tool 300. In one embodiment, the tubular thread seal 100 is inserted over an application tool 300. The application tool 120 is inserted over the threaded connection 120, and the tubular thread seal 100 is slid from the application tool 300 over the threaded connection 120.

The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A tubular thread seal comprising:
a proximal edge with a specified proximal diameter;
a distal edge with a specified distal diameter, wherein the distal edge is inserted over a threaded connection; and
a tube disposed between the proximal edge and the distal edge.

2. The tubular thread seal of claim 1, wherein the tube is rolled from the distal edge with a curvature outside of the tube.

3. The tubular thread seal of claim 2, wherein the tube is unrolled from a threaded connection proximal end over the threaded connection.

4. The tubular thread seal of claim 1, further comprising a roll tab rolled with the tube, wherein pulling the roll tab unrolls the tube.

5. The tubular thread seal of claim 1, wherein distal edge is folded over the tube toward the proximal edge and wherein the distal edge is unfolded from the proximal end of the threaded connection over the threaded connection.

6. The tubular thread seal of claim 5, further comprising a pull tab disposed on the distal edge.

7. The tubular thread seal of claim 1, wherein the tube is folded with an accordion fold.

8. The tubular thread seal of claim 7, further comprising a pull tab disposed on the distal edge.

9. The tubular thread seal of claim 1, further comprising an end cap at least partially connecting the proximal edge.

10. The tubular thread seal of claim 9, the proximal edge comprising a perforation separating the end cap from a proximal edge, wherein the end cap is removed from the tube by tearing along the perforation.

11. The tubular thread seal of claim 10, the end cap further comprising a cap tab.

12. The tubular thread seal of claim 1, further comprising an end cap removal tool that cuts the end cap from the tube.

13. The tubular thread seal of claim 1, wherein the specified proximal diameter is in the range of 10-105% of a diameter of the threaded connection.

14. The tubular thread seal of claim 1, wherein the specified distal diameter is in the range of 15-110% of a diameter of the threaded connection.

15. The tubular thread seal of claim 1, wherein the tube has a diameter in the range of 0.3 to 15 centimeters and a length in the range of 0.3 to 16 centimeters.

16. The tubular thread seal of claim 1, wherein the tube comprises a material selected from the group consisting of a polymer, an elastomer, and a polytetrafluoroethylene.

17. The tubular thread seal of claim 1, further comprising plumber's paste disposed on the tube.

18. The tubular thread seal of claim 1, further comprising an application tool, wherein the tubular thread seal is inserted over the application tool, the application tool is inserted over the threaded connection, and the tubular thread seal is slid from the application tool over the threaded connection.

19. The tubular thread seal of claim 1, wherein the tube has a roughness Ra in the range of 100,000 to 20,000.

20. The tubular thread seal of claim 1, wherein the tube has an interior surface selected from the group consisting of a flat surface, a ridged surface, and a textured surface.
